(19) United States
(12) Patent Application Publication
(10) Pub. No.: US 2021/0177096 A1
(43) Pub. Date: Jun. 17, 2021

(54) ARTICLE OF FOOTWEAR AND METHOD OF MANUFACTURING THE SAME

(71) Applicant: NIKE, Inc., Beaverton, OR (US)

(72) Inventors: SH Park, Portland, OR (US); Aleksandra Pollner, Portland, OR (US)

(73) Assignee: NIKE, Inc., Beaverton, OR (US)

(21) Appl. No.: 17/023,768

(22) Filed: Sep. 17, 2020

Related U.S. Application Data
(60) Provisional application No. 62/947,770, filed on Dec. 13, 2019.

(51) Int. Cl. A43B 23/02; A43B 23/24

(52) U.S. Cl. CPC A43B 23/0235; A43B 23/24; A43B 23/025; A43B 23/0255

(57) ABSTRACT

An article of footwear and a method of manufacturing the same is provided. The article of footwear comprises a sole structure and an upper fixedly attached thereto. The upper comprises a base layer and a plurality of scrap material pieces. The scrap material pieces comprise appliqués disposed on and coupled to a surface of the base layer. The scrap material pieces are collectively positioned on the surface of the base layer in a custom arrangement. The method of manufacture is designed to be an environmentally-friendly and sustainable process, wherein the scrap material of a first footwear application is utilized in a second footwear application. The method of manufacture comprises dividing the scrap material of a first footwear application into scrap material pieces and coupling the scrap material pieces, in the custom arrangement, to the exterior surface of the base layer of the upper of a second footwear application.

### CROSS-REFERENCE TO RELATED APPLICATIONS

This application claims the benefit of U.S. Provisional Application No. 62/947,770, filed Dec. 13, 2019, which is hereby incorporated by reference in its entirety.

### TECHNICAL FIELD

The present disclosure generally relates to an article of footwear and a method of manufacturing an article of footwear.

### BACKGROUND

Footwear often includes many components of many different materials. An article of footwear typically includes a sole structure configured to be located under a wearer's foot to space the foot away from the ground. A footwear upper attached to the sole structure receives the foot. Footwear manufacturing strives to provide high quality, durable footwear in an environmentally conscience manner.

### SUMMARY

An article of footwear and a method of manufacturing the same is provided. The article of footwear may comprise a sole structure and an upper fixedly attached to the sole structure, with the sole structure being configured to receive a foot of the wearer. The upper may further comprise a base layer and a plurality of scrap material pieces. The scrap material pieces comprise appliqués disposed on and coupled to an exterior-facing surface of the base layer. The scrap material pieces are collectively positioned relative to one another, such that the plurality of scrap material pieces forms a custom arrangement upon the exterior surface of the base layer.

The method of manufacturing the article of footwear is designed to be an environmentally friendly and sustainable process, wherein scrap material of a first footwear application is utilized in a second footwear application to reduce material waste. The method of manufacture, therefore, comprises coupling scrap material pieces, formed from the scrap material of the first footwear application, to the exterior surface of the base layer of the upper of a second footwear application, such that the scrap material pieces are positioned in a custom arrangement.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a schematic, perspective view of a first side of an article of footwear including a sole structure, an upper, and a plurality of scrap material pieces coupled to and disposed upon an exterior surface of the upper.

FIG. 2 is a schematic, exploded, perspective view of the first side of the article of footwear of FIG. 1.

FIG. 3 is a schematic perspective view of the upper including the base layer having a plurality of scrap material pieces positioned thereon and secured thereto via a plurality of stitch lines.

FIG. 4 is a schematic, perspective view of a second side of an article of footwear including a sole structure, an upper, and a plurality of scrap material pieces coupled to and disposed upon an exterior surface of the upper.

FIG. 5 is a schematic, perspective, top view of a footwear pair comprising a first article of footwear and a second article of footwear having scrap material pieces positioned on the upper of the first article of footwear in a first custom arrangement and scrap material pieces positioned on the upper of the second article of footwear in a different, second custom arrangement.

FIG. 6 is a schematic, perspective, rear view of a heel region, including a heel counter of an article of footwear including a sole structure, an upper, and a plurality of scrap material pieces coupled to and disposed upon the exterior surface of the upper.

FIG. 7 is a flow chart of the example method of manufacturing the article of footwear of FIGS. 1-6.

FIG. 8 is a flow chart of the example method of manufacturing the article of footwear of FIGS. 1-6, further detailing the step of coupling the scrap material pieces from a first footwear application to an exterior surface of a base layer of an upper of a second footwear application.

### DETAILED DESCRIPTION

While the present disclosure may be described with respect to specific applications or industries, those skilled in the art will recognize the broader applicability of the disclosure.

The terms “a,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. For example, a longitudinal direction of a shoe extends between a forefoot region and a heel region of the shoe. The term “forward” or “anterior” is used to refer to the general direction from a heel region toward a forefoot region, and the term “rearward” or “posterior” is used to refer to the opposite direction, i.e., the direction from the forefoot region toward the heel region. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. For example, a transverse direction of a shoe extends between a lateral side and a medial side of the shoe. The transverse direction or axis may also be referred to as a lateral direction or axis or a mediolateral direction or axis.

The term “vertical”, as used throughout this detailed description and in the claims, refers to a direction generally perpendicular to both the lateral and longitudinal directions. For example, in cases where a sole is planted flat on a ground surface, the vertical direction may extend from the ground surface upward. It will be understood that each of these directional adjectives may be applied to individual components of a sole. The term “upward” or “upwards” refers to the vertical direction pointing towards a top of the component, which may include an instep, a fastening region and/or a throat of an upper. The term “downward” or “downwards” refers to the vertical direction pointing opposite the upwards direction, toward the bottom of a component and may generally point towards the bottom of a sole structure of an article of footwear.

In addition, the term “proximal” refers to a direction that is nearer a center of a footwear component, or is closer toward a foot when the foot is inserted in the article of footwear as it is worn by a user. Likewise, the term “distal” refers to a relative position that is further away from a center of the footwear component or is further from a foot when the foot is inserted in the article of footwear as it is worn by a user. Thus, the terms proximal and distal may be understood to provide generally opposing terms to describe relative spatial positions.

To assist and clarify the subsequent description of various embodiments, various terms are defined herein. Unless otherwise indicated, the following definitions apply throughout this specification (including the claims). An “article of footwear”, a “footwear article of manufacture”, and “footwear” may be considered to be both a machine and a manufacture. Assembled, ready to wear footwear articles (e.g., shoes, sandals, boots, etc.), as well as discrete components of footwear articles (such as a midsole, an outsole, an upper component, etc.) prior to final assembly into ready to wear footwear articles, are considered and alternatively referred to herein in either the singular or plural as “article(s) of footwear”.

The following discussion and accompanying figures disclose various footwear configurations and methods relating to manufacturing of the same. Although the article of footwear 10 is depicted as athletic footwear configured for sports, such as sneakers, in the associated Figures, concepts associated with the configurations and methods may be applied to various other types of athletic footwear articles, such as a hiking boots and shoes, soccer shoes, football shoes, running shoes, cross-training shoes, rugby shoes, basketball shoes, etc. However, the article of footwear 10 is not limited to sneakers or other sports shoes. In some embodiments, the disclosed provisions may be configured for use with various kinds of non-sports-related footwear, including but not limited to, boots, leisure shoes, dress shoes, work shoes, sandals, slippers, or any other category of footwear, which may also incorporate concepts discussed herein.

In a general sense, the article of footwear 10 of the present disclosure footwear is designed to be manufactured in an environmentally friendly and sustainable process. In this way, scrap material from a first footwear application is utilized in a second footwear application to reduce material waste.

The article of footwear 10 may comprise an upper 12 fixedly attached to a sole structure 14. The upper 12 further comprising a base layer 18 and a plurality of scrap material pieces 20 or appliqués. The scrap material pieces 20 may comprise appliqués disposed on and coupled to an exterior-facing surface 22 of the base layer 18. The scrap material pieces 20 may be collectively positioned relative to one another, such that the plurality of scrap material pieces 20 forms a custom arrangement 50, 52 (FIG. 4) upon the exterior surface 22 of the upper 12.

The method of manufacture, therefore, comprises receiving scrap material from a first footwear application, dividing the scrap material into scrap material pieces 20, and coupling the scrap material pieces 20 from a first footwear application to the exterior surface 22 of the base layer 18 of the upper of a second footwear application, such that the scrap material pieces 20 are positioned in a custom arrangement 50, 52.

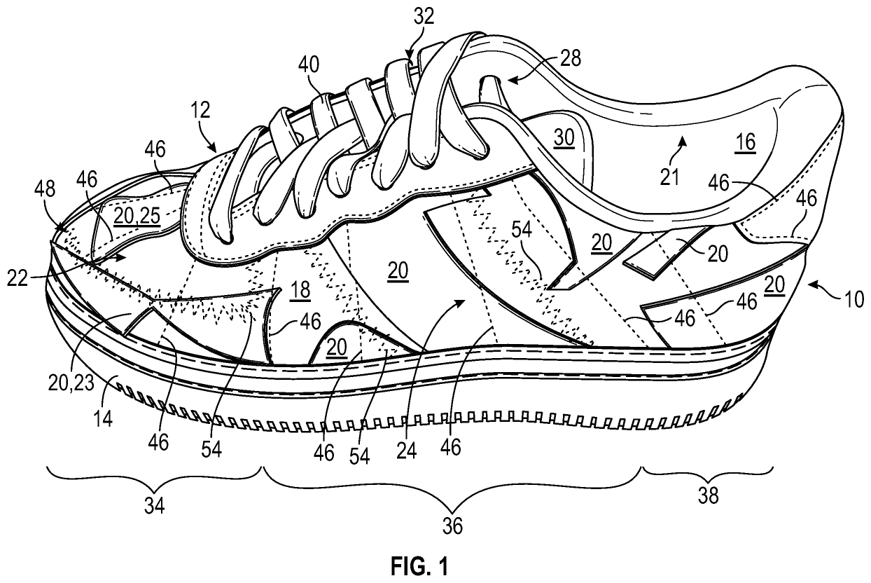

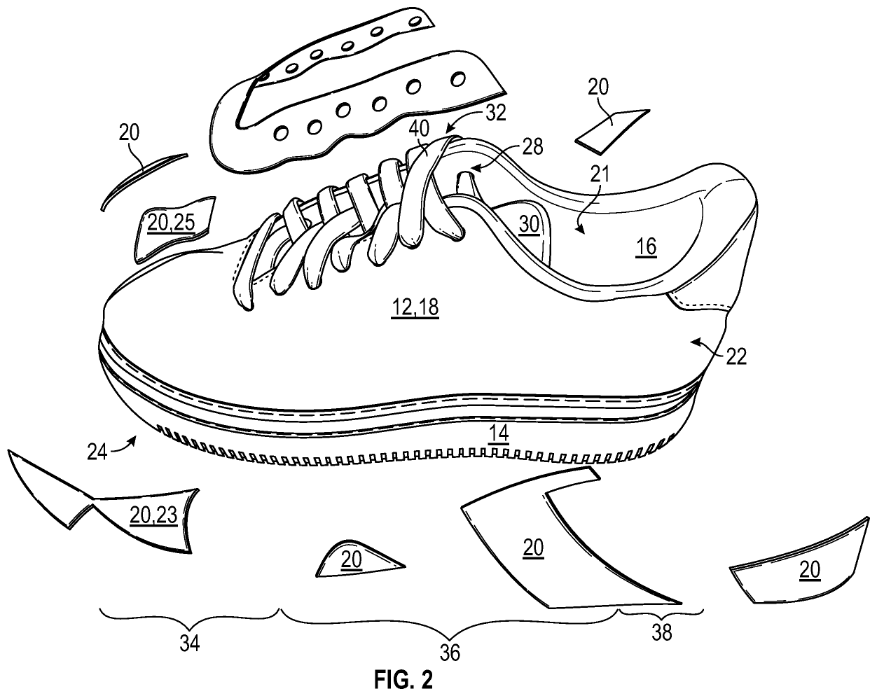

Referring to the drawings, wherein like reference numerals refer to like components throughout the several views, an article of footwear 10 is provided. As shown in FIGS. 1-6, the article of footwear 10 comprises an upper 12 fixedly attached to a sole structure 14.

The upper 12 is a portion of the article of footwear 10 that defines an interior cavity 16 adapted to receive a foot of a wearer. For the purpose of consistency and clarity, the “interior” of the article of footwear 10 refers to space that is occupied by a wearer's foot when the article of footwear 10 is worn. The “inner side” of a panel or other shoe element refers to the face of that panel or element that is (or will be) oriented toward the interior in a completed article of footwear 10. The “outer side” or “exterior” of an element refers to the face of that element that is (or will be) oriented away from the interior in a completed article of footwear 10.

As indicated in FIGS. 1-6, the article of footwear 10 may be divided into a forefoot region 34, a midfoot region 36, and a heel region 38, which are likewise the forefoot region, the midfoot region, and the heel region, of the sole structure 14 and the upper 12 respectively. The forefoot region 34 generally includes portions of the article of footwear 10 corresponding with the toes and the joints connecting the metatarsals with the phalanges. The midfoot region 36 generally includes portions of the article of footwear 10 corresponding with the arch area and instep of the foot. The heel region 38 corresponds with rear portions of the foot, including the calcaneus bone. The forefoot region 34, the midfoot region 36, and the heel region 38 are not intended to demarcate precise areas of the footwear 10, but are instead intended to represent general areas of the footwear 10 to aid in the following discussion.

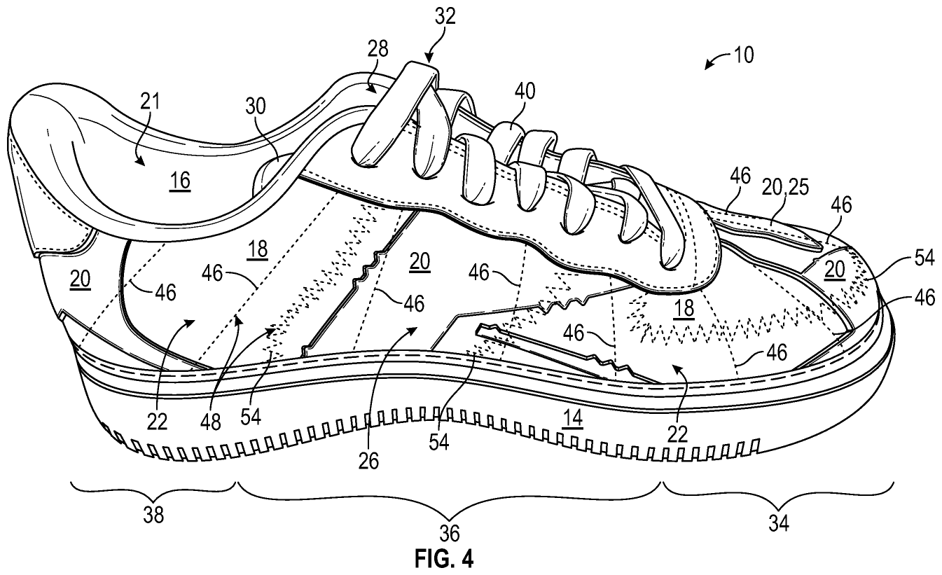

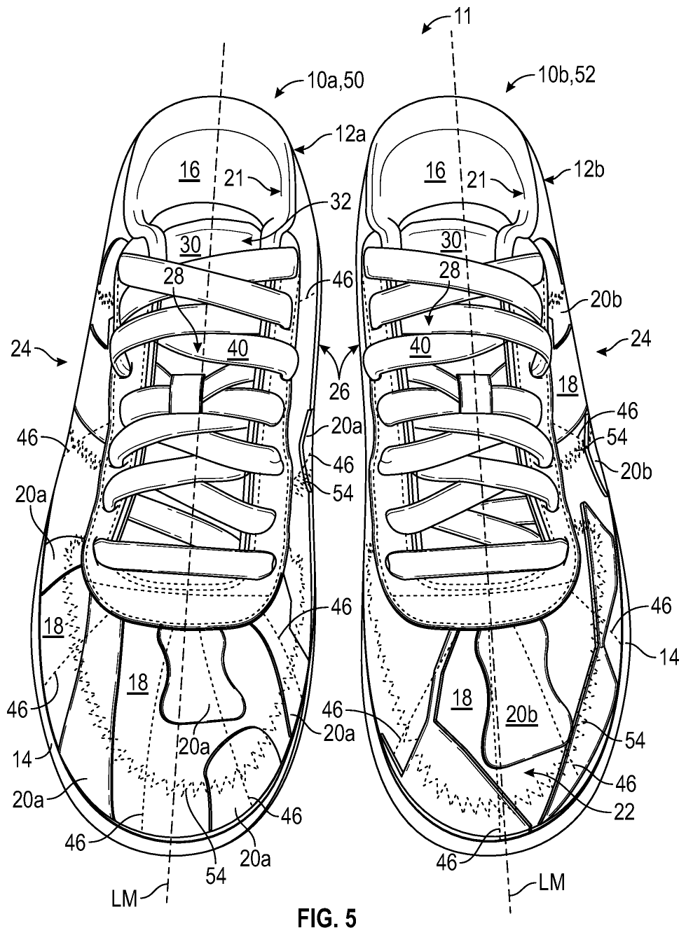

The article of footwear 10 has a first side portion or lateral side portion 24 (FIG. 1) and a second side portion or medial side portion 26 (FIG. 4). The lateral side portion 24 and medial side portion 26 extend through each of the forefoot region 34, the midfoot region 36, and the heel region 38, and correspond with opposite sides of the article of footwear 10, each falling on an opposite side of a longitudinal midline LM of the article of footwear 10, partially indicted in FIG. 5. The medial side portion 26 is thus considered opposite to the lateral side portion 24.

The sole structure 14 may include provisions for attenuating ground reaction forces (i.e., cushioning and stabilizing the foot during vertical and horizontal loading). In addition, sole structure 14 may be configured to provide traction, impart stability, and control or limit various foot motions, such as pronation, supination, or other motions. For example, the disclosed concepts may be applicable to footwear configured for use on any of a variety of surfaces, including indoor surfaces or outdoor surfaces. In some embodiments, the sole structure 14 may be configured to provide traction and stability on hard indoor surfaces (such as hardwood); soft, natural turf surfaces; or on hard, artificial turf surfaces.

In different embodiments, the sole structure 14 may include different components, which may, individually or collectively, provide an article with a number of attributes, such as support, rigidity, flexibility, stability, cushioning, comfort, reduced weight, or other attributes. For example, the sole structure 14 may include a midsole, an outsole, and a cushioning layer and/or insole. The midsole may be formed from a compressible polymer foam element (e.g., a polyurethane or ethylvinylacetate foam) that attenuates ground reaction forces (i.e., provides cushioning) when compressed between the foot and the ground during walking, running, or other ambulatory activities. In further configurations, the midsole may incorporate fluid-filled chambers, plates, moderators, or other elements that further attenuate forces, enhance stability, or influence the motions of the foot. The midsole may be a single, one-piece midsole, or could be multiple components integrated as a unit. In some embodiments, the midsole may be integrated with the outsole as a unisole. The outsole may be one-piece, or may be several outsole components, and may be formed from a wear-resistant elastomeric, e.g., rubber, material that may be textured to impart traction and/or may include traction elements such as cleats secured to the midsole.

When the foot is positioned within the foot-receiving interior cavity 16 of the article of footwear 10, it is supported on a foot-facing surface of the midsole and an interior surface 21 of the base layer 18 of the upper 12. Optionally, the foot-facing surface of the midsole may be covered by a strobel (not shown) secured to a lower region of the upper 12. Also, optionally, an insole (not shown) may rest on the strobel or directly on the sole structure 14 in embodiments without a strobel, in which case the foot is supported by both the sole structure 14 and the insole.

It may be appreciated however that the sole structure 14 is not limited to incorporating traditional sole components and may incorporate various different kinds of elements arranged at the outermost, innermost, and intermediate ‘layers’, or locations, of the sole. Thus, the sole structure 14 can include an outer sole member or element, which may or may not coincide with a conventional ‘outsole’. Likewise, the sole structure 14 may include an inner sole member or element, which may or may not be an ‘insole’. Further, the sole structure 14 can include any number of intermediate and/or middle sole members or elements, which may or may not be a ‘midsole’.

The sole structure 14 may be permanently and/or fixedly attached to one or more portions of the upper 12 (for example, with adhesive, stitching, welding, or other suitable techniques) and may have a configuration that extends between upper 12 and the ground. For purposes of this disclosure, the term “permanently attached” shall refer to two components joined in a manner such that the components may not be readily separated (for example, without destroying one or both of the components). In addition, two components may be “permanently attached” by virtue of being integrally formed, for example, through a molding process.

In general, the upper 12 includes provisions to reduce any tendency of the foot to be pulled away from the sole structure 14 during use. In some embodiments, the upper 12 may be a conventional upper defining an interior cavity 16 for receiving a foot of the wearer. The upper 12 may be formed of a variety of materials, such as leather, textiles, polymers, cotton, foam, composites, etc. The upper 12 may include a base layer 18 of a material that has elasticity, breathability, or both in order to aid with foot insertion and comfort. For example, the base layer 18 may be a polymeric material capable of providing elasticity, and may be of a braided construction, a knitted (e.g., warp-knitted) construction, or a woven construction.

In other embodiments, the upper 12 may be configured to provide a ‘tension fit’ about a wearer's foot. As used herein, the term tension fit refers to a fit that ensures the upper is pulled against the foot at all times including on a lower side where the sole of the foot contacts a bottom portion of the upper 12. In some cases, a tension fit upper may be configured so that when no foot is present within the interior cavity 16, the interior cavity 16 has a volume that is smaller than the volume after a foot has been inserted. In other words, the upper 12 may be configured to stretch or expand as a foot is inserted. As discussed in further detail below, such a configuration may provide an upper 12 that ‘stays with’ the foot, and especially the sole of the foot, at all times during any activities (e.g., running, jumping, walking, etc.). A tension fit may or may not require stretching in the upper. In some cases, the upper 12 can be configured to stretch significantly when a foot is inserted. In other cases, however, the upper 12 may simply fit the foot very snugly without significant expansion.

In the present disclosure, as illustrated in FIGS. 1-5, the upper 12 comprises a base layer 18 that defines the interior cavity 16 adapted to receive a foot of a wearer. The base layer 18, thereby has an interior surface 21 and an exterior surface 22. The base layer 18 of the upper 12 may be formed of a variety of materials, such as leather, textiles, polymers, cotton, foam, composites, etc. The base layer 18 of the upper 12 may further include a first side portion or lateral side portion 24 (FIG. 1) and a second side portion or medial side portion 26 (FIG. 4), such that the base layer 18 further defines a throat opening 28 disposed between the first side portion or lateral side portion 24 (FIG. 1) and a second side portion or medial side portion 26 (FIG. 4).

The throat opening 28 may permit a wearer's foot to extend into the interior cavity 16 of the upper 12. The throat opening 28 may be further configured to house a closure system 32, such as laces 40 or the like, that may selectively couple the lateral side 24 and the medial side 26 across the throat opening 28, while providing an ability to adjust the girth of the upper 12. The closure system 32 may generally include a unitary closure panel or tongue portion 30 and a plurality of laces 40 each extending between the lateral side portion 24 and the medial side portion 26 of the base layer 18. The tongue portion 30 may be integrated with or separately secured to the base layer 18. The tongue portion 30 may extend over the instep region of the foot.

It is desirable to reduce waste materials in the manufacture of footwear. As such re-using or repurposing of scrap material is beneficial in both the design aspects of the article of footwear 10, as well in the sustainability of manufacturing operations. As discussed herein, in a general sense, the article of footwear 10 of the present disclosure is designed to be manufactured in an environmentally friendly and sustainable process 100.

Accordingly, as detailed by the method of manufacture 100 disclosed herein and shown by example in FIGS. 7-8, scrap material from a first footwear application may be utilized in the design and manufacture of a second footwear application. In this way, as shown in Steps 101-102 of FIG. 7, scrap material may be obtained or harvested from a first footwear application, at Step 101, and subsequently divided into scrap material pieces 20 at Step 102. A custom arrangement 50, 52 for the scrap material pieces 20 upon the base layer 18 of the upper 12 is then determined at Step 103, and the scrap material pieces 20 are positioned upon (Step 104) and coupled to (Step 105) the base layer 18 of the upper 12.

The article of footwear 10 disclosed herein is an article of the second footwear application, and, as such, the scrap material pieces 20 may be coupled to the exterior surface 22 of the base layer 18 of the upper 12.

Accordingly, referring back to the upper 12, as shown in FIGS. 1-6 the upper may further include the plurality of scrap material pieces 20 disposed on and coupled to the exterior surface 22 of the base layer 18, such that the scrap material pieces 20 comprise appliques disposed on the exterior surface 22 of the base layer 18. The scrap material pieces 20 may be scrap material from another footwear application, and may be formed of a variety of materials, such as leather, textiles (woven or nonwoven), polymers, cotton, foam, composites, etc.

The scrap material pieces 20 may vary in shape, size, and orientation. With respect to shape, each scrap material piece 20 may have its own unique shape, or several scrap material pieces may maintain the same shape. Said another way, the plurality of scrap material pieces 20 may comprise at least a first scrap material piece 23 having a first shape and a second scrap material piece 25 having a second shape. In some example embodiments, the first shape and the second shape may be the same. In other example embodiments, the first shape may be different than the second shape.

Likewise, with respect to size, each scrap material piece 20 may have its own unique size or several scrap material pieces may maintain the same size. Said another way, the plurality of scrap material pieces 20 may comprise the first scrap material piece 23 having a first size and the second scrap material piece 25 having a second size. In some example embodiments, the first size and the second size may be substantially similar. In other example embodiments, the first size may be larger than the second size. In still other example embodiments, the first size may be smaller than the second size.

With respect to orientation, each scrap material piece 20 may be positioned relative to each of the other scrap material pieces 20, such that the plurality of scrap material pieces 20 forms a custom arrangement 50, 52 upon the exterior surface 22 of the upper 12 (FIG. 5). In this way, for example, each of the scrap material pieces 20 may be spaced apart from each of the other scrap material pieces 20. Further, each of the scrap material pieces 20 may be obliquely angled with respect to each of the other scrap material pieces 20.

Further, in some embodiments, a substantially similar number of scrap material pieces 20 may be disposed in each of the forefoot region 34, the midfoot region 36, and the heel region 38 of the respective article of footwear 10. For example, at least one of the scrap materials pieces 20 may be disposed on and coupled to the exterior surface 22 of the upper 12 within each of the forefoot region 34, the midfoot region 36, and the heel region 38. In other embodiments, a substantially different number of scrap material pieces 20 may be disposed in each of the forefoot region 34, the midfoot region 36, and the heel region 38 of the respective article of footwear 10. For example, each of the forefoot region 34, the midfoot region 36, and the heel region 38 may contain no scrap material pieces 20 or multiple scrap material pieces 20.

In any case, the scrap material pieces 20 are collectively positioned in a unique or custom arrangement 50, 52 on the exterior surface 22 of the upper 12. In some examples, each of the forefoot region 34, the midfoot region 36, and the heel region 38 of the respective article of footwear 10 may contain at least one scrap material piece 20, such that the respective custom arrangement 50, 52 is a balanced arrangement.

The custom arrangement 50, 52 of the scrap material pieces 20 on the exterior surface 22 of the base layer 18 is truly unique or custom to each article of footwear 10, such that the base layer 18 may be characterized by an absence of locating features thereon, which would indicate the precise placement of the scrap material pieces 20. The absence of such locating features allows the placement of the scrap material pieces 20, and in essence the organization of the custom arrangement 50, 52, to be substantially randomized, in that the placement of the scrap material pieces 20 upon the exterior surface 22 of the base layer 18 is at least partially within the discretion of the assembler of the article of footwear 10. In this way, the custom arrangement 50, 52 is truly unique from shoe-to-shoe, and, as such, it will be extremely unlikely that two articles of footwear 10 will maintain the same custom arrangement 50, 52, even two articles of footwear 10 within a distinct footwear pair 11. In some embodiments, placement of the scrap material pieces 20 may be according to some general guidelines, e.g., one piece 20 in the heel region 38, two pieces 20 on the lateral side portion 24, etc.; however, in such embodiments the article of footwear 10 still is without locating features, such that the resulting arrangement 50, 52 is customized.

For example, as detailed in step 103, the custom arrangement 50, 52 is determined.

More particularly, a first custom arrangement 50 is determined and a second custom arrangement 52 is determined. In this way, the article of footwear 10 may be a first article of footwear 10a within a footwear pair 11 (FIG. 5), such that the upper 12 is a first upper 12a and the plurality of scrap material pieces 20 is a first plurality of scrap material pieces 20a, which are disposed or positioned upon the base layer 18 of the first upper 12a in the first custom arrangement 50 (Step 104). The footwear pair 11 may further comprise a second article of footwear 10b having a second upper 12b and a second plurality of scrap material pieces 20b disposed or positioned upon the base layer 18 of the second upper 12b in a second custom arrangement 52 (Step 104). In many embodiments, the first custom arrangement 50 is different than the second custom arrangement 52. However, it is possible for the first custom arrangement 50 to be substantially similar to the second custom arrangement 52.

At Step 105, the scrap material pieces 20 are coupled to the exterior surface 22 of the base layer 18 of the upper 12, such that the scrap material pieces 20 form appliqués on the exterior surface 22 of the base layer 18. Coupling the scrap material pieces 20 to the exterior surface 22 of the base layer 18 may entail several sub-steps as shown in FIG. 8. First, at sub-step 201 a resin binder may be applied to each of the scrap material pieces 20. The resin binder may be formulated as a coating, an adhesive, or the like. At sub-step 202, the scrap material pieces 20 may be adhered to the exterior surface 22 of the base layer 18 with the resin binder, such that the scrap material pieces 20 are disposed in the custom arrangement 50, 52 determined in Step 104.

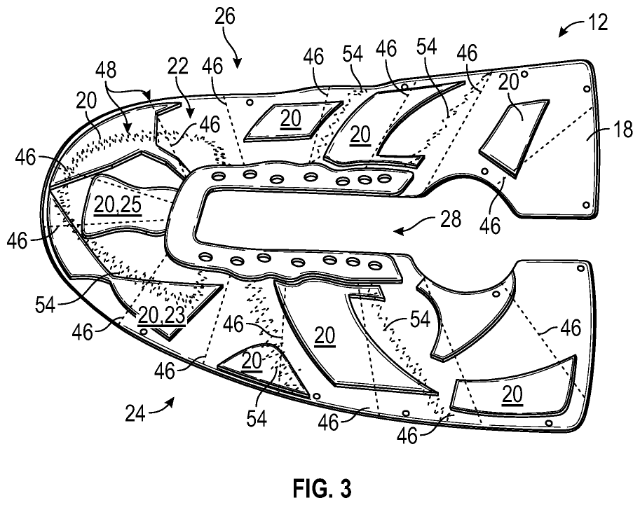

After the scrap material pieces 20 are adhered to the exterior surface 22 of the base layer 18 in sub-step 202, the scrap material pieces 20 are further secured to the exterior surface 22 of the base layer 18 via a plurality of stitch lines 46. In this way, each of the scrap material pieces 20 is sewn onto the base layer 18 of the upper 12 via the stitch lines 46, as detailed in sub-step 203 in FIG. 8. Stitching may occur while the base layer 18 is in a planar position, prior to attachment to the sole structure 14 as shown in FIG. 3.

As shown in FIGS. 1-6, the plurality of stitch lines 46 may be embodied as a series of straight-quilt stitches. The plurality of stitch lines 46 may further include a series of zigzag stitches 54. The plurality of stitch lines 46 may be embodied as a combination of a series of zigzag stitches 54 and a plurality of straight-quilt stitches 46.

As shown in FIGS. 1-6, the plurality of stitch lines 46 may define a predetermined stitch pattern 48. The predetermined stitch pattern 48 may be consistent from shoe-to-shoe. For example, in an embodiment wherein the article of footwear 10 may be a first article of footwear 10a within a footwear pair 11, wherein the footwear pair 11 further comprises a second article of footwear 10b, the predetermined stitch pattern 48 may be the same on each of the first article of footwear 10a and the second article of footwear 10b despite the difference between the first custom arrangement 50 and the second custom arrangement 52 (FIG. 5). Said another way, the scrap material pieces 20 on any given article of footwear 10, regardless of the custom arrangement 50, 52, are secured to the exterior surface 22 of the base layer 18 via the same predetermined stitch pattern 48.

The stitch lines 46 may be selectively positioned in each of the forefoot region 34, the midfoot region 36, and the heel region 38 on each of the lateral side 24 and the medial side 26. In some embodiments, each of the forefoot region 34, the midfoot region 36, and the heel region 38 may maintain a substantially similar number of stitch lines 46. In some examples, each of the stitch lines 46 may be non-intersecting with each of the other stitch lines 46. Further, each of the plurality of stitch lines 46 may be spaced apart from each of the other stitch lines 46. Within any predetermined stitch pattern 48, the stitch lines 46 are positioned in such a way that each of the scrap material pieces 20 is traversed by at least one of the respective stitch lines 46. In this way, the respective stitch line 46 secures the respective scrap material piece 20 to the base layer 18.

In one example, the stitch lines 46 may be configured as a series of straight-quilt stitches 46 extending between the throat opening 28 and the sole structure 14 and upper 12, and more particularly, between the throat opening 28 and the bight line or the abutment of the upper 12 and the sole structure 14. In such an example, the spacing of the stitch lines 46 within the predetermined stitch pattern 48 may be a function of the size of the scrap material pieces 20. For example, smaller scrap material pieces 20 may facilitate a need for additional stitch lines 46 or less spacing or distance between stitch lines 46, whereas larger scrap material pieces 20 may allow for less total stitch lines 46 or more spacing or distance between stitch lines 46.

Predetermined spacing of the stitch lines 46 enables the ability for the custom arrangement 50, 52 of the scrap material pieces 20. Due to the customized nature of the custom arrangement 50, 52, the placement of the scrap material pieces 20 may vary from shoe-to-shoe, but the predetermined stitch pattern 48 may remain constant. In this way, a stitching machine may be pre-programmed with the predetermined stitch pattern 48, for each customized shoe, thereby increasing manufacturing efficiencies. The stitch lines 46 may be applied to the upper 12 in the predetermined stitch pattern 48 via a hand stitching or via a pre-programmable machine stitching process.

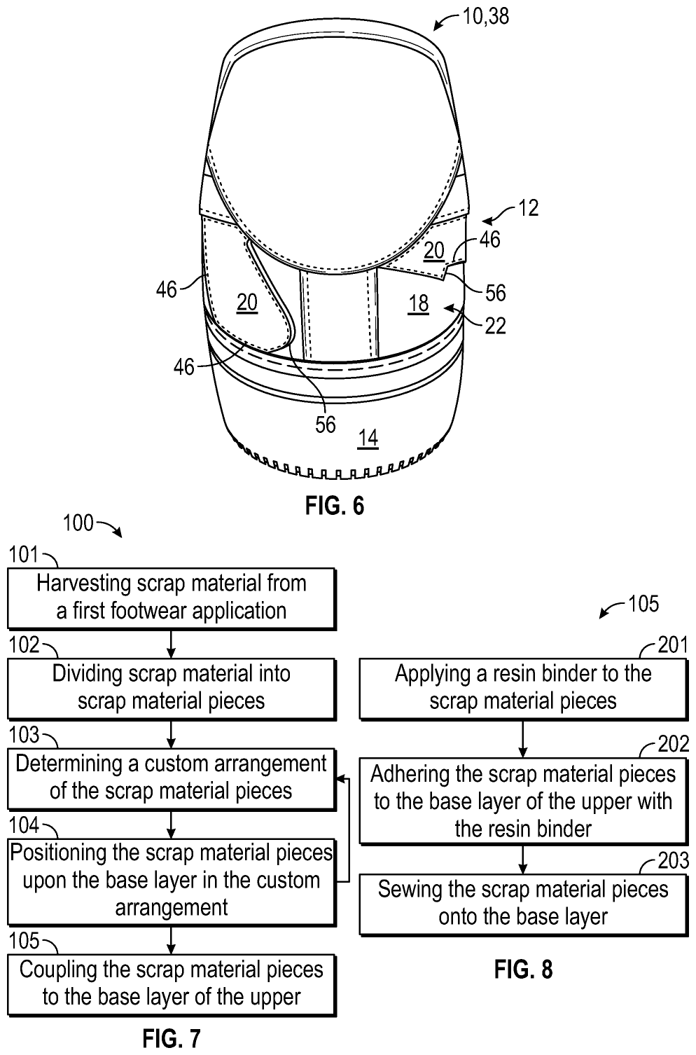

In another example, each of the scrap material pieces 20 has an outer boundary 56. In such an example, a respective one of the stitch lines 46 traverses the respective scrap material piece 20 along an entirety of its outer boundary 56 (FIG. 6). In this way, the scrap material piece 20 is sewn on to the base layer 18 by tracking the outer boundary 56 of the respective scrap material piece 20 with one of the stitch lines 46. The stitch lines 46 may be applied to the upper 12 in the predetermined stitch pattern 48 via a hand stitching or via a machine stitching process, such as a vision-guided stitching machine process. In such an example, wherein the stitch lines 46 may be applied to the upper 12 via a vision-guided stitching machine, the respective vision-guided stitching machine may be a controller-regulated, vision-guided stitching system for assembling engineered textiles. The controller-regulated, vision-guided stitching system includes a movable end effector, such as a pneumatic articulating robot arm or a motor-driven carriage. Further, the controller-regulated, vision-guided stitching system incudes a stitching head, which is mounted to the movable end effector, and includes one or more thread feeders and a sewing needle that cooperatively generates stitches. Also mounted to the movable end effector is an image capture device that captures images of the workpiece and outputs data indicative thereof.

The controller-regulated, vision-guided stitching system also includes a resident or remote system controller, which may be embodied as an electronic control unit or a network of distributed controllers or control modules that regulate operation of one or more resident processing systems. The system controller may be wired or wirelessly connected to the movable end effector, stitching head, and image capture device.

This controller is programmed to receive, from the image capture device, the data indicative of the captured image of the workpiece, and locate, from the captured image, the location of the outer boundary 56 (FIG. 6) of the respective scrap material piece 20. Once the locations of the outer boundary 56 of the respective scrap material pieces 20 are located, the system controller transmits one or more command signals to the movable end effector to sequentially move the stitching head across the workpiece and thereby align the sewing needle with the outer boundary 56 of the respective scrap material piece 20. The system controller concurrently transmits one or more command signals to the stitching head to insert a succession of stitches, at a predetermined stitch density, tracking around the outer boundary 56 of the respective scrap material pieces 20. In this way, the scrap material piece 20 is sewn on to the base layer 18 by tracking the outer boundary 56 of the respective scrap material piece 20 with one of the stitch lines 46.

In a general sense, the article of footwear 10 of the present disclosure is designed to be unique and customized, while being manufactured in an environmentally friendly and sustainable process. In this way, scrap material from a first footwear application is utilized in a second footwear application to reduce material waste. Accordingly, the method of manufacturing 100 the article of footwear 10 is designed to be an environmentally friendly and sustainable process, wherein scrap material of a first footwear application is utilized in a second footwear application to reduce material waste. The method of manufacture, therefore, comprises coupling scrap material pieces 20, formed from the scrap material of the first footwear application, to the exterior surface of the base layer 18 of the upper 12 of a second footwear application, such that the scrap material pieces 20 are positioned in a custom arrangement 50, 52.

The following Clauses provide example configurations of an article of footwear disclosed herein.

Clause 1. An article of footwear comprising an upper comprising a base layer and a plurality of scrap material pieces disposed on and coupled to an exterior surface of the base layer.

Clause 2. The article of footwear of clause 1 wherein the surface is an exterior surface, and wherein the scrap material pieces comprise appliques disposed upon the exterior surface of the base layer of the upper.

Clause 3. The article of footwear of clause 2, wherein each scrap material piece is positioned relative to each of the other scrap material pieces, such that the plurality of scrap material pieces forms a custom arrangement upon the exterior surface of the upper.

Clause 4. The article of footwear of any of clauses 1-3, wherein the scrap material pieces comprise at least a first scrap material piece having a first shape and a second scrap material piece having a second material shape, and wherein the first shape is different than the second shape.

Clause 5. The article of footwear of any of clauses 1-4, wherein each of the scrap material pieces is spaced apart from each of the other scrap material pieces.

Clause 6. The article of footwear of any of clauses 1-5, wherein each of the scrap material pieces is spaced apart from each of the other scrap material pieces.

Clause 7. The article of footwear of any of clauses 1-6, wherein each of the plurality of scrap material pieces is coupled to the surface of the upper with a resin binder.

Clause 8. The article of footwear of any of clause 7, wherein the upper further includes a plurality of stitch lines defining a predetermined stitch pattern.

Clause 9. The article of footwear of clause 8 wherein each of the scrap material pieces is traversed by at least one of the stitch lines.

Clause 10. The article of footwear of any of clauses 8-9, wherein the each of the stitch lines is spaced apart from each of the other stitch lines.

Clause 11. The article of footwear of any of clause 10, wherein each of the scrap material pieces has an outer boundary, and wherein a respective one of the stitch lines traverses the respective scrap material piece along an entirety of the outer boundary.

Clause 12. The article of footwear of any of clauses 8-11, wherein each of the stitch lines is non-intersecting with each of the other stitch lines.

Clause 13. The article of footwear of any of clauses 8-12 wherein at least one of the stitch lines comprises a series of zigzag stitches.

Clause 14. The article of footwear of any of clauses 8-12, wherein the plurality of stitch lines comprises a plurality of straight-quilt stitch lines.

Clause 15. The article of footwear of any of clauses 8-11, further comprising a sole structure fixedly attached to the upper, wherein the base layer of the upper defines a throat opening, and wherein each of the stitch lines extends between the throat opening and the sole structure.

Clause 16. The article of footwear of clause 15 wherein the upper has a lateral side and a medial side and further defines a forefoot region, a midfoot region, and a heel region; each of the lateral side and the medial side extend into the forefoot region, the midfoot region, and the heel region; and the plurality of stitch lines extend between the throat opening and the sole structure within in each of the forefoot region, the midfoot region, and the heel region on each of the lateral side and the medial side.

Clause 17. The article of footwear of clause 16, wherein a respective one of the scrap material pieces is disposed on and coupled to the surface of the upper at each of the forefoot region, the midfoot region, and the heel region.

Clause 18. A method of manufacturing an article of footwear, the method of manufacturing comprising coupling the scrap material pieces from a first footwear application to an exterior surface of a base layer of an upper of a second footwear application, such that the scrap material pieces form appliqués on the exterior surface of the base layer.

Clause 19. The method of clause 18 further comprising receiving scrap material from the first footwear application; and dividing the scrap material into the scrap material pieces.

Clause 20. The method of any of clauses 18-19 wherein the scrap material pieces are a first plurality of scrap material pieces, the upper is a first upper, and the article of footwear is a first article of footwear.

Clause 21. The method of clause 20 wherein the method further comprises: prior to coupling the first plurality of scrap material pieces to the base layer of the first upper, determining a first arrangement of the first plurality of scrap material pieces; positioning the first plurality of scrap material pieces on the exterior surface of the base layer of the first upper in the first arrangement.

Clause 22. The method of clause 21 wherein the method further comprises determining a second arrangement of a second plurality of scrap material pieces from the first footwear application, wherein the second arrangement is different from the first arrangement; positioning the second plurality of scrap material pieces on an exterior surface of a base layer of a second upper of a second article of footwear of the second footwear application in the second arrangement; and coupling the second plurality of scrap material pieces to the exterior surface of the base layer of the second upper in the second arrangement.

Clause 23. The method of any of clauses 18-22, wherein coupling the scrap material pieces to the exterior surface of the base layer further comprises applying a resin binder to each of the scrap material pieces.

Clause 24. The method of clause 23 wherein coupling the scrap material pieces to the exterior surface of the base layer further comprises adhering each of the respective scrap material pieces to the exterior surface of the base layer with the resin binder.

Clause 25. The method of any of clauses 18-24 wherein coupling the scrap material pieces to the exterior surface of the base layer further comprises sewing the scrap material pieces to the exterior surface of the base layer with a plurality of stitch lines, such that each of the scrap material pieces is traversed by at least one of the stitch lines.

Clause 26. The method of clause 25 wherein sewing the plurality of scrap material pieces to the exterior surface of the base layer with the plurality of stitch lines, such that each of the scrap material pieces is traversed by at least one of the stitch lines further comprises tracking an outer boundary of each of the scrap material pieces with at least one of the stitch lines.

Clause 27. The method of clause 25 wherein sewing the plurality of scrap material pieces to the exterior surface of the base layer with the plurality of stitch lines, such that each of the scrap material pieces is traversed by at least one of the stitch lines further comprises configuring the stitch lines as a series of straight-quilt stitches extending from a throat opening of the base layer to a sole structure fixed to the base layer, wherein each of the series of straight-quilt stitches is spaced apart from and non-intersecting with each of the other series of straight-quilt stitches.

Clause 28. An article of footwear comprising an upper having a base layer, wherein the base layer defines an exterior surface; a plurality of appliqués disposed on and coupled to a surface of the base layer in a first custom arrangement; and a plurality of stitch lines configured to couple the appliqués to the base layer, the plurality of stitch lines arranged in a predetermined pattern, wherein each of the appliqués is traversed by at least one of the stitch lines.

Clause 29. The article of footwear of clause 28 wherein each of the appliqués comprises a scrap material piece.

Clause 30. The article of footwear of any clauses 28-29 wherein each of the stitch lines is spaced apart from and non-intersecting with each of the other stitch lines.

Clause 31. The article of footwear of any of clauses 29-30, wherein the appliqués comprise at least a first scrap material piece having a first shape and a second scrap material piece having a second shape, and wherein the first shape is different than the second shape.

Clause 32. The article of footwear of any of clauses 28-31 wherein each of the scrap material pieces is spaced apart from each of the other scrap material pieces.

Clause 33. The article of footwear of any of clauses 28-32 wherein the article of footwear is a first article of footwear of a footwear pair.

Clause 34. The article of footwear of clause 33 wherein the footwear pair further comprises a second article of footwear having a second upper with a second base layer and a second plurality of appliqués disposed on and coupled to a surface of the second base layer in a second custom arrangement, the second plurality of appliqués comprising a plurality of second scrap material pieces.

Clause 35. The article of footwear of clause 34 further comprising a second plurality of stitch lines configured to couple the second plurality of appliqués to the second base layer, the second plurality of stitch lines arranged in the predetermined pattern of the stitch lines of the first article of footwear, wherein each of the second scrap material pieces is traversed by at least one of the stitch lines of the second plurality of stich lines.

Clause 36. The article of footwear of any of clauses 34-35 wherein the first custom arrangement is different than the second custom arrangement.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

What is claimed is:

1. An article of footwear comprising:
an upper comprising a base layer and a plurality of scrap material pieces disposed on and coupled to a surface of the base layer.

2. The article of footwear of claim 1 wherein:
the surface is an exterior surface;
the scrap material pieces comprise appliqués disposed upon the exterior surface of the upper; and
each scrap material piece is positioned relative to each of the other scrap material pieces, such that the plurality of scrap material pieces forms a custom arrangement upon the exterior surface of the upper.

3. The article of footwear of claim 1 wherein the plurality of scrap material pieces comprises at least a first scrap material piece having a first shape and a second scrap material piece having a second shape, and wherein the first shape is different than the second shape.

4. The article of footwear of claim 1 wherein each of the scrap material pieces is spaced apart from each of the other scrap material pieces.

5. The article of footwear of claim 1 wherein the plurality of scrap material pieces is coupled to the surface of the upper with a resin binder.

6. The article of footwear of claim 5 wherein the upper further includes a plurality of stitch lines defining a predetermined stitch pattern; and wherein each of the scrap material pieces is traversed by at least one of the stitch lines.

7. The article of footwear of claim 6 wherein the each of the stitch lines is spaced apart from each of the other stitch lines, and wherein each of the stitch lines is non-intersecting with each of the other stitch lines.

8. The article of footwear of claim 7 wherein each of the scrap material pieces has an outer boundary, and wherein a respective one of the stitch lines traverses the respective scrap material piece along an entirety of the outer boundary.

9. The article of footwear of claim 7 further comprising:
a sole structure fixedly attached to the upper;
wherein the upper has a lateral side and a medial side and further defines a forefoot region, a midfoot region, and a heel region, such that each of the lateral side and the medial side extend into the forefoot region, the midfoot region, and the heel region;
wherein the base layer of the upper defines a throat opening; and
wherein the stitch lines extend from the throat opening to the sole structure within each of the forefoot region, the midfoot region, and the heel region on each of the lateral side and the medial side.

10. The article of footwear of claim 9 wherein a respective one of the scrap material pieces is disposed on and coupled to the surface of the upper at each of the forefoot region, the midfoot region, and the heel region.

11. A method of manufacturing an article of footwear, the method of manufacturing comprising:
coupling scrap material pieces from a first footwear application to an exterior surface of a base layer of an upper of a second footwear application, such that the scrap material pieces form appliqués on the exterior surface of the base layer.

12. The method of claim 11, further comprising:
receiving scrap material from the first footwear application; and
dividing the scrap material into the scrap material pieces.

13. The method of claim 11 wherein the scrap material pieces are a first plurality of scrap material pieces, the upper is a first upper, and the article of footwear is a first article of footwear, and wherein the method further comprises:
prior to coupling the first plurality of scrap material pieces to the base layer of the first upper, determining a first arrangement of the first plurality of scrap material pieces;
positioning the first plurality of scrap material pieces on the exterior surface of the base layer of the first upper in the first arrangement;
determining a second arrangement of a second plurality of scrap material pieces from the first footwear application, wherein the second arrangement is different from the first arrangement;
positioning the second plurality of scrap material pieces on an exterior surface of a base layer of a second upper of a second article of footwear of the second footwear application in the second arrangement; and
coupling the second plurality of scrap material pieces to the exterior surface of the base layer of the second upper in the second arrangement.

14. The method of claim 11 wherein coupling the scrap material pieces to the exterior surface of the base layer further comprises:
applying a resin binder to each of the scrap material pieces; and
adhering each of the scrap material pieces to the exterior surface of the base layer with the resin binder.

15. The method of claim 14 wherein coupling the scrap material pieces to the exterior surface of the base layer further comprises:
sewing the scrap material pieces to the exterior surface of the base layer with a plurality of stitch lines, such that each of the scrap material pieces is traversed by at least one of the stitch lines.

16. The method of claim 15 wherein sewing the scrap material pieces to the exterior surface of the base layer with the plurality of stitch lines, such that each of the scrap material pieces is traversed by at least one of the stitch lines further comprises:
tracking an outer boundary of each of the scrap material pieces with at least one of the stitch lines.

17. The method of claim 15 wherein sewing the scrap material pieces to the exterior surface of the base layer with the plurality of stitch lines, such that each of the scrap material pieces is traversed by at least one of the stitch lines further comprises:
configuring the stitch lines as a series of straight-quilt stitches extending from a throat opening of the base layer to a sole structure fixed to the base layer, wherein each of the series of straight-quilt stitches is spaced apart from and non-intersecting with each of the other series of straight-quilt stitches.

18. An article of footwear comprising:
an upper comprising a base layer, wherein the base layer defines an exterior surface;
a plurality of appliqués disposed on and coupled to the exterior surface of the base layer in a first custom arrangement, such that each of the appliqués is spaced apart from each of the other appliqués; and
a plurality of stitch lines configured to couple the appliqués to the base layer, the plurality of stitch lines arranged in a predetermined pattern, wherein each of the appliqués is traversed by at least one of the stitch lines.

19. The article of footwear of claim 18 wherein:
the plurality of appliqués comprises at least a first scrap material piece having a first shape and a second scrap material piece having a second shape, and wherein the first shape is different than the second shape; and
each of the stitch lines is spaced apart from and non-intersecting with each of the other stitch lines.

20. The article of footwear of claim 19 wherein the article of footwear is a first article of footwear of a footwear pair, the footwear pair further comprising:
a second article of footwear having a second upper comprising a second base layer having a second exterior surface and a second plurality of appliqués disposed on and coupled to the second exterior surface of the second base layer in a second custom arrangement, such that each of the appliqués of the second plurality of appliqués is spaced apart from each of the other appliqués of the second plurality of appliqués, wherein the second plurality of appliqués is a second plurality of scrap material pieces;
a second plurality of stitch lines configured to couple the second plurality of appliqués to the second base layer, the second plurality of stitch lines arranged in the predetermined pattern of the stitch lines of the first article of footwear, wherein each of the second plurality of appliqués is traversed by at least one of the stitch lines of the second plurality of stich lines; and
wherein the first custom arrangement is different than the second custom arrangement.
